(19) United States
(12) Patent Application Publication
(10) Pub. No.: US 2005/0194765 A1
(43) Pub. Date: Sep. 8, 2005

(54) Target tote

(76) Inventor: George R. Easterling, Shawnee, OK (US)

Correspondence Address: James T. Robinson;Exclusivity-Law, Inc., 222 East Main Street, Norman, OK, 73069-1303, US

(21) Appl. No.: 10/794,224

(22) Filed: Mar. 5, 2004

(51) Int. Cl. B62B 1/00

(52) U.S. Cl. 280/656

(57) ABSTRACT

A target tote provides a mobile platform which supports a life-size, three-dimensional decoy. A longitudinal tubular member supports one or more adjustable supports which are positionable on the longitudinal tubular member to accommodate decoys of different sizes. The target tote invention may also include a carcass carrier attached to the longitudinal tubular member, a T-shaped towing handle, and a yoke for attaching the longitudinal tubular member to the towing handle or to an all terrain vehicle. The T-shaped towing handle is stored within the longitudinal tubular member.

### BACKGROUND OF THE INVENTION

1. Field of the Invention

This invention relates to a mobile platform for life-size, three-dimensional archery targets and hunting decoys, and more particularly, but not by way of limitation, to a mobile platform which is towed behind an all terrain vehicle or pulled by a handle. As used herein, the term decoys will refer both to life-size, three-dimensional decoys and also to life-size, three-dimensional targets. The term target tote, as used herein, refers to a mobile platform for transporting either targets or decoys.

2. Discussion

Life-size targets and decoys are popular with hunters of deer, elk, and moose. Because the decoys are life-size, they are bulky to transport to a desired hunting destination. At the destination, the decoys must be secured while the hunter assumes a strategic position. Typically, the decoy mounted on two stakes which must be driven into the ground.

Not all ground is suitable for location of the decoys. The presence of rock often prevents the use of stakes. Mud and sand are not sufficiently firm to provide an anchor to secure the decoys.

### SUMMARY OF THE INVENTION

Applicant's target tote invention provides a mobile platform which supports one or more life-size, three-dimensional decoys. A longitudinal member supports one or more risers (also referred to herein as adjustable supports) on which the decoy is mounted. The risers are positionable on the longitudinal tubular member to accommodate decoys of different sizes. The target tote invention may also include a carcass carrier attached to the longitudinal tubular member and a stowable T-shaped handle.

### BRIEF DESCRIPTION OF THE DRAWINGS

FIG. 1 shows a side view of a life-size, three dimensional decoy mounted on a target tote according to the present invention.

FIG. 2 is a front plan view of applicant's target tote invention shown in FIG. 1 wherein the wheels are mounted on separate axles.

FIG. 3 is a top plan view of a portion of applicant's invention.

FIG. 4 shows a side view of a life-size, three dimensional decoy mounted on another target tote according to the present invention.

FIG. 5 is a view of the target tote according to the present invention with a carcass carrier attached thereto.

FIG. 6 is a detailed view of applicant's invention, partially cut away, showing the connection of applicant's invention to an all terrain vehicle.

FIG. 7 is a cross-sectional view of a portion of applicant's invention.

FIG. 8 is a front view of applicant's target tote invention wherein the wheels are mounted on a single axle and the transverse member containing the axle is attached to a collar which slides onto the longitudinal tubular member.

FIG. 9 illustrates storage of a T-shaped towing handle in the longitudinal tubular member.

FIG. 10 shows how the T-shape towing handle shown in FIG. 9 is secured within the longitudinal tubular member 12 for storage.

### DETAILED DESCRIPTION OF THE INVENTION

In the following description of the invention, like numerals and characters designate like elements throughout the figures of the drawings.

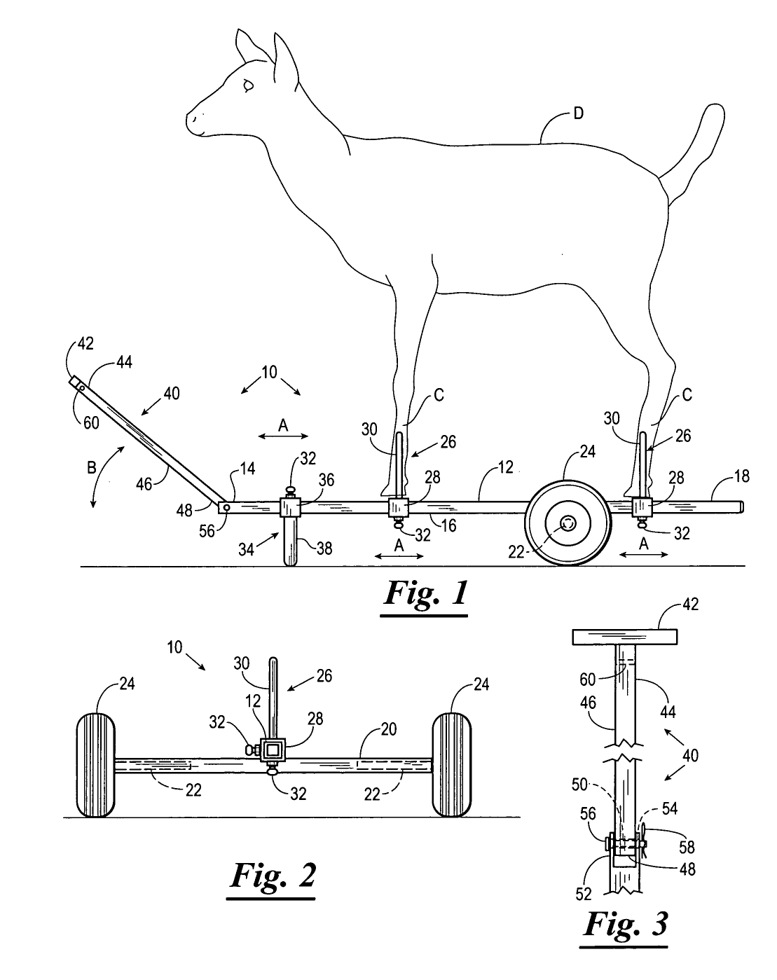

Referring now to the drawings generally and to FIGS. 1 and 2 in particular, a target tote 10 in accordance with the present invention supports a three-dimensional decoy D. A longitudinal tubular member 12 has a front end portion 14, an intermediate portion 16, and a rear end portion 18. A transverse tubular member 20 is attached to the longitudinal tubular member 12 generally aft of the middle portion 16 and encloses an axle 22. Wheels 24 are attached to the axle 22 enclosed within the transverse tubular member 20. Two adjustable supports 26 support the decoy D. Each adjustable support 26 has a collar 28 and a vertical member 30 extending upwardly from the collar 28. The collars 28 slide on the longitudinal tubular member 12 along arrow A to accommodate the dimensions of the decoy D. The collars 28 are just larger than the longitudinal tubular member 12 (see FIGS. 2 and 7). The vertical members 30 are received by in the cavities C of the decoy D and the decoy D is supported by the adjustable supports 26. The collars 28 are secured in place on the longitudinal tubular member 12 by thumb screws 32.

Still referring to FIGS. 1 and 2, a front rest 34 positioned near the front end portion 14 of the longitudinal tubular member 12 keeps the longitudinal tubular member 12 in a generally horizontal alignment. The front rest 34 includes a collar 36 and a downwardly extending toe member 38. The collar 36 slides on the longitudinal member 12 along arrow A and is secured in place by a thumb screw 32.

Referring now to FIGS. 1 and 3, a T-shaped handle 40 is used to pull the target tote 10 short distances. The T-shaped handle 40 has a transverse bar 42 attached to an upper end portion 44 of a handle member 46. The handle member 46 has a lower end portion 48 containing a transverse bore 50. The lower end portion 48 of the handle member 46 is received by a yoke 52 at the front end portion 14 of the longitudinal tubular member 12. A mating transverse bore 54 in the yoke 52 mates with the transverse bore 50 in the lower end portion 48 of the handle member 46. A pin 56 extends through the transverse bore 50 and the mating transverse bore 54 and is held in place by a key 58 (see FIGS. 3 and 6). The upper end portion 44 and the transverse bar 42 move along arrow B as the T-shaped handle 40 pivots on the pin 56 within the yoke 52. A transverse bore 60 near the upper end portion 44 of the handle member 46 is used to secure the T-shaped towing handle 40 within the longitudinal tubular member 12 for storage (see FIGS. 9 and 10).

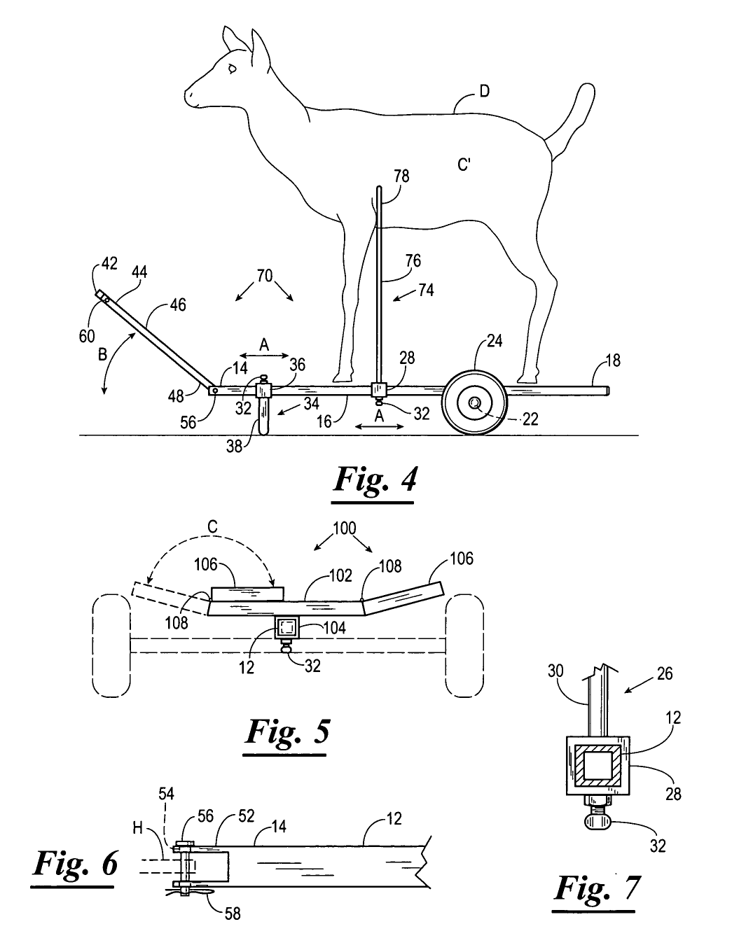

Referring now to FIG. 4, another target tote 70 according to the present invention includes a single adjustable support 74. The adjustable support 74 includes a collar 28 which slides on the longitudinal support member 12 and is secured in place by a thumb screw 32. The single adjustable support 74 includes an elongated upwardly extending vertical member 76 having a top portion 78. The top portion 78 of the elongated upwardly extending vertical member 76 is received in a cavity C′ of the decoy D. The transverse bore 60 near the upper end portion 44 of the handle member 46 is used to secure the T-shaped towing handle 40 within the longitudinal tubular member 12 for storage (see FIGS. 9 and 10).

Referring now to FIG. 5, a carcass carrier 100 includes a base member 102 which is attached to a collar 104. The collar 104 slides on the longitudinal tubular member 12 and is secured by a thumb screw 32. Swingout wing members 106 attached to ends of the base member 102 by hinges 108 swing along arrow C from a folded position for transporting the decoy D on applicant's target tote invention to a deployed position for supporting a carcass.

Referring now to FIG. 6, the yoke 52 located at the front end portion 14 of the longitudinal tubular member 12 is attached to an all terrain vehicle hitch member H.

Referring now to FIG. 7, a detail of the adjustable support 26 illustrates the mounting of the collar 28 on the longitudinal tubular member 12. The collar 28 is secured to the longitudinal tubular member 12 by the thumb screw 32. The vertical member 30 extends upwardly from the collar 28.

As illustrated in FIGS. 1-6, the transverse tubular member 20 is welded to the longitudinal tubular member 12. Likewise, the base member 102 is welded to the longitudinal tubular member 12. It will be understood by one skilled in the art that the transverse tubular member 20 and the base member 102 could be bolted to the longitudinal tubular member 12.

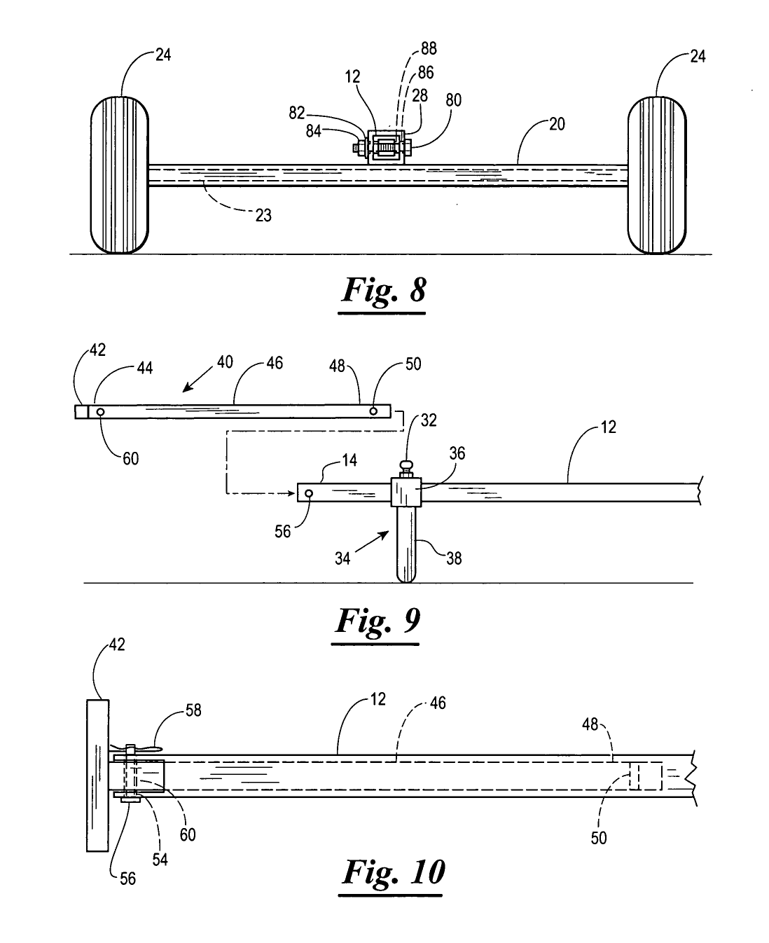

Referring now to FIG. 8, the wheels 24 are attached to a solid axle 23 disposed within the transverse tubular member 20. The collar 28, which is shown as welded to the transverse tubular member 20, slides onto the longitudinal tubular member 12 and is secured in place by a bolt 80. The bolt 80 is disposed through holes 86 in the collar 28 and holes 88 in the longitudinal tubular member 12. A washer 82 and a nut 84 are used to attach the welded collar-transverse tubular member assembly to the longitudinal tubular member 12.

Referring now to FIGS. 9 and 10, the handle member 46 of the T-shaped towing handle 40 slides into the longitudinal tubular member 12 and is secured in place by the pin 56. The pin 56 extend through the transverse bores 54 in the yoke 52 and the transverse bore 60 near the upper end portion 44 of the handle member 46. The key 58 holds the pin 56 in place.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A mobile platform for towing a life-size, three-dimensional decoy having at least one downwardly facing cavity, comprising:
a longitudinal member;
a transverse tubular member attached to said longitudinal member;
an axle disposed within each end of said transverse tubular member;
a wheel attached to each said axle; and
at least one adjustable support slidably attached to said longitudinal member, so that said adjustable support supports the life-size, three-dimensional decoy.

2. The device of claim 1, wherein said adjustable support further comprises:
a collar slidably attached to said longitudinal member;
an upwardly extending vertical member attached to said collar; and
at least one thumb screw attached to said collar to secure said collar in a fixed position on said longitudinal member, so that the cavity in the life-size, three-dimensional cavity receives the upwardly extending vertical member.

3. The device of claim 1, wherein said longitudinal member is characterized as having a front end portion, an intermediate portion, and a rear end portion, said device further comprising attaching means for attaching said front end portion of said longitudinal member to an all terrain vehicle.

4. The device of claim 3, wherein the all terrain vehicle has a hitch member, the hitch member has a transverse bore therethrough, and said attaching means further comprises:
a yoke attached to said front end portion of said longitudinal member, said yoke having a transverse bore therethrough, so that the all terrain vehicle hitch member is received within said yoke so that the hitch member transverse bore aligns with said yoke transverse bore;
a pin disposed through said hitch member transverse bore and said yoke transverse bore; and
a key securing said pin.

5. The device of claim 1, further comprising a carcass carrier attached to said mobile platform, said carcass carrier comprising:
a collar slidably attached to said longitudinal member;
a transverse base member attached to said collar; and
a swingout wing member hingedly attached to each end of said base member, so that a carcass can be secured to said transverse base member and at least one said swingout wing member.

6. The device of claim 1, further comprising a front rest attached to said longitudinal member, said front rest comprising:
a collar slidable attached to said longitudinal member;
a downwardly extending toe member attached to said collar; and
at least one thumb screw attached to said collar for securing said collar in fixed position on said longitudinal member.

7. The device of claim 5, further comprising a carcass carrier attached to said mobile platform, said carcass carrier comprising:
a collar slidably attached to said longitudinal member;
a transverse base member attached to said collar; and
a swingout wing member hingedly attached to each end of said base member, so that a carcass can be secured to said transverse base member and at least one said swingout wing member.

8. The device of claim 6, further comprising a carcass carrier attached to said mobile platform, said carcass carrier comprising:
a collar slidably attached to said longitudinal member;
a transverse base member attached to said collar; and
a swingout wing member hingedly attached to each end of said base member, so that a carcass can be secured to said transverse base member and at least one said swingout wing member.

9. The device of claim 1, wherein said longitudinal member is characterized as having a front end portion, an intermediate portion, and a rear end portion, said device further comprising:
a T-shaped towing handle having a transverse bar attached to a handle member, said handle member having an upper end portion and a lower end portion, wherein said transverse bar is attached to said upper end portion of said handle member; and
attaching means for attaching said front end portion of said longitudinal member to said lower end portion of said handle member.

10. The device of claim 9, wherein said handle member has a transverse bore through said lower portion of said handle member and wherein said attaching means for attaching said front end portion of said longitudinal member to said lower end portion of said handle member further comprises:
a yoke attached to said front end portion of said longitudinal member, said yoke having a transverse bore therethrough, so that said lower portion of said handle member is received within said yoke so that said transverse bore in said lower portion of said handle member aligns with said yoke transverse bore;
a pin disposed through said handle member transverse bore and said yoke transverse bore; and
a key securing said pin within said handle member transverse bore and said yoke transverse bore.

11. A mobile platform for towing a life-size, three-dimensional decoy having at least one downwardly facing cavity, comprising:
a longitudinal member;
a transverse tubular member attached to said longitudinal member;
an axle disposed within said transverse tubular member, said axle having ends extending beyond the ends of said transverse tubular member;
a wheel attached to each end of said axle; and
at least one adjustable support slidably attached to said longitudinal member, so that said adjustable support supports the life-size, three-dimensional decoy.

12. The device of claim 11, wherein said adjustable support further comprises:
a collar slidably attached to said longitudinal member;
an upwardly extending vertical member attached to said collar; and
at least one thumb screw attached to said collar to secure said collar in a fixed position on said longitudinal member, so that the cavity in the life-size, three-dimensional cavity receives the upwardly extending vertical member.

13. The device of claim 11, wherein said longitudinal member is characterized as having a front end portion, an intermediate portion, and a rear end portion, said device further comprising attaching means for attaching said front end portion of said longitudinal member to an all terrain vehicle.

14. The device of claim 13, wherein the all terrain vehicle has a hitch member, the hitch member has a transverse bore therethrough, and said attaching means further comprises:
a yoke attached to said front end portion of said longitudinal member, said yoke having a transverse bore therethrough, so that the all terrain vehicle hitch member is received within said yoke so that the hitch member transverse bore aligns with said yoke transverse bore;
a pin disposed through said hitch member transverse bore and said yoke transverse bore; and
a key securing said pin.

15. The device of claim 11, further comprising a carcass carrier attached to said mobile platform, said carcass carrier comprising:
a collar slidably attached to said longitudinal member;
a transverse base member attached to said collar; and
a swingout wing member hingedly attached to each end of said base member, so that a carcass can be secured to said transverse base member and at least one said swingout wing member.

16. The device of claim 11, further comprising a front rest attached to said longitudinal member, said front rest comprising:
a collar slidable attached to said longitudinal member;
a downwardly extending toe member attached to said collar; and
at least one thumb screw attached to said collar for securing said collar in fixed position on said longitudinal member.

17. The device of claim 15, further comprising a carcass carrier attached to said mobile platform, said carcass carrier comprising:
a collar slidably attached to said longitudinal member;
a transverse base member attached to said collar; and
a swingout wing member hingedly attached to each end of said base member, so that a carcass can be secured to said transverse base member and at least one said swingout wing member.

18. The device of claim 16, further comprising a carcass carrier attached to said mobile platform, said carcass carrier comprising:
a collar slidably attached to said longitudinal member;
a transverse base member attached to said collar; and
a swingout wing member hingedly attached to each end of said base member, so that a carcass can be secured to said transverse base member and at least one said swingout wing member.

19. The device of claim 11, wherein said longitudinal member is characterized as having a front end portion, an intermediate portion, and a rear end portion, said device further comprising:
a T-shaped towing handle having a transverse bar attached to a handle member, said handle member having an upper end portion and a lower end portion, wherein said transverse bar is attached to said upper end portion of said handle member; and
attaching means for attaching said front end portion of said longitudinal member to said lower end portion of said handle member.

20. The device of claim 19, wherein said handle member has a transverse bore through said lower portion of said handle member and wherein said attaching means for attaching said front end portion of said longitudinal member to said lower end portion of said handle member further comprises:
a yoke attached to said front end portion of said longitudinal member, said yoke having a transverse bore therethrough, so that said lower portion of said handle member is received within said yoke so that said transverse bore in said lower portion of said handle member aligns with said yoke transverse bore;
a pin disposed through said handle member transverse bore and said yoke transverse bore; and
a key securing said pin within said handle member transverse bore and said yoke transverse bore.

21. The device of claim 10, wherein said handle member has a transverse bore in said upper end portion of said handle member, said handle member is slidably received within said longitudinal tubular member, and said handle member is secured in place by said pin disposed through said handle member upper portion transverse bore and said yoke transverse bore.

22. The device of claims, wherein said transverse tubular member is welded to said longitudinal member.

23. The device of claim 1, wherein said transverse tubular member is welded to a collar having a bore therethrough, said collar is slidable received on said longitudinal tubular member, and said collar is secured to said longitudinal tubular member by a threaded bolt disposed through said bore in said collar and through a mating more in said longitudinal tubular member, said bolt being secured by a nut attached to the threaded end of said bolt.
